(19) United States
(12) Patent Application Publication
(10) Pub. No.: US 2012/0261368 A1
(43) Pub. Date: Oct. 18, 2012

(54) PORTABLE STORAGE AND DISPLAY RACK FOR MULTIPLE FIREARMS

(76) Inventors: Roger Julius Klein, Rancho Santa Margarita, CA (US); Ryan Jeffrey Klein, Aliso Viejo, CA (US)

(21) Appl. No.: 13/443,626

(22) Filed: Apr. 10, 2012

Related U.S. Application Data
(60) Provisional application No. 61/476,442, filed on Apr. 18, 2011.

(51) Int. Cl. B60R 7/14

(52) U.S. Cl. 211/64

(57) ABSTRACT

Devices for storing and displaying one or more firearms. Embodiments of the present rack accommodate a variety of firearm types and sizes. The rack has unique design elements and attributes that provide for portability, security, accessibility, and/or accessory storage.

### CROSS-REFERENCE TO RELATED APPLICATION

This application claims priority to provisional application Ser. No. 61/476,442, filed on Apr. 18, 2011, the entire contents of which are hereby incorporated by reference.

### BACKGROUND

The present invention relates to storage and display devices for firearms.

### DESCRIPTION OF RELATED ART

Currently, storage devices for firearms that are known to the inventors do not provide for easy, safe, and stable portability of multiple firearms as a single unit, such as from secure-storage to a work area, showcase, or display table. Known storage devices for firearms also cannot be used in public or retail environments, because they lack effective methods of securing the firearms to the storage device, such that any individual firearm can't be removed. Known storage devices for firearms, when used in confined storage areas, such as a safe or a secure storage cabinet, do not allow for easy accessibility of an individual firearm without repositioning the storage device or wasting storage space by requiring extra headroom for the storage device. Space is frequently limited in such storage areas. Known storage devices for firearms also do not provide accessory or parts storage space for items such as spare magazines, cleaning rods, take-down tools, or extra grips, so that they can be stored with the associated firearm(s).

### SUMMARY

The various embodiments of the present portable storage and display rack for multiple firearms have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One embodiment of the present portable storage and display racks for multiple firearms comprises a substantially flat base, and first and second handles extending upwardly from opposite ends of the base. The rack further comprises a plurality of spaced barrel supports extending upwardly from a rear portion of the base. Each barrel support comprises a support post that extends substantially vertically upward from the base, and a barrel-receiving portion that extends diagonally upward and away from the upper end of the base and toward an interior area of the rack.

### BRIEF DESCRIPTION OF THE DRAWINGS

The various embodiments of the present portable storage and display rack for multiple firearms now will be discussed in detail with an emphasis on highlighting the advantageous features. These embodiments depict the novel and non-obvious portable storage and display rack for multiple firearms shown in the accompanying drawings, which are for illustrative purposes only. These drawings include the following figures, in which like numerals indicate like parts:

FIG. 1 is a front perspective view of one embodiment of the present portable storage and display rack for multiple firearms;

FIG. 2 is a front perspective view of the portable storage and display rack of FIG. 1 with a handgun mounted and secured thereto;

FIG. 3 is a top perspective view of an accessory tray configured for use with the portable storage and display rack of FIG. 1;

FIG. 4 is a side perspective view of the portable storage and display rack of FIG. 1 in combination with the accessory tray of FIG. 3; and

FIG. 5 is a front perspective view of the combination of FIG. 4.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The embodiments of the present portable storage and display rack for multiple firearms are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

As described below, the present embodiments, which for simplicity will be referred to as a “rack,” include devices for storing and displaying one or more firearms. Embodiments of the present rack are designed to accommodate a variety of firearm types and sizes. The present embodiments are particularly well suited for accommodating handguns, but alternative embodiments may be suited for accommodating other types of firearms. The rack has unique design elements and attributes, described below, that provide for portability, security, accessibility, and accessory storage. The present embodiments solve a portability problem in the prior art by incorporating ergonomic, strong, full-size handles at each end of the rack and firmly secured thereto. The handles allow an entire rack of firearms to be picked up as a single unit and easily and safely transported from one location to another, such as from secure storage, to a work area, showcase, or display table. The handles accommodate very large adult-sized hands, and are long enough so that the hands can be positioned in the middle of each handle, toward the front, or toward the back, so that the rack can be balanced in an ergonomic position. The handles also serve as an attachment point for an optional temporary firearm securing means during movement or transportation, such as a rubber strap or elastic cord.

The present embodiments solve a security problem in the prior art where storage racks are used in public and retail environments by providing the closed-loop handles, which serve as cable passageways. A sturdy cable or chain can be threaded through the trigger guards of the firearms and looped around one or both of the handles, and the free ends of the cable locked together with a padlock. The entire rack of firearms is thus secured such that no individual firearm can be removed. The full-size handles additionally serve as a closed-loop cable passageway to attach the rack to another similar rack, or to a substantially immovable object/securing point, thereby providing a complete security solution.

The present embodiments solve an accessibility in confined areas problem in the prior art by providing mounting points for each firearm that are at an advantageous height and angle such that little headroom clearance is required to easily, and without damage to the firearm, remove or replace an individual firearm without repositioning or partially removing the storage rack.

The present embodiment embodiments solve an accessories/parts storage problem in the prior art by providing the above mounting points that leave sufficient room above the base of the rack, below the mounted firearms, and between the full-size handles to allow an accessories/parts tray to fit within the rack's space envelope. The optional integrated storage tray allows items like spare magazines, cleaning rods, take-down tools, and/or extra grips to be conveniently stored in close proximity to their associated firearm(s).

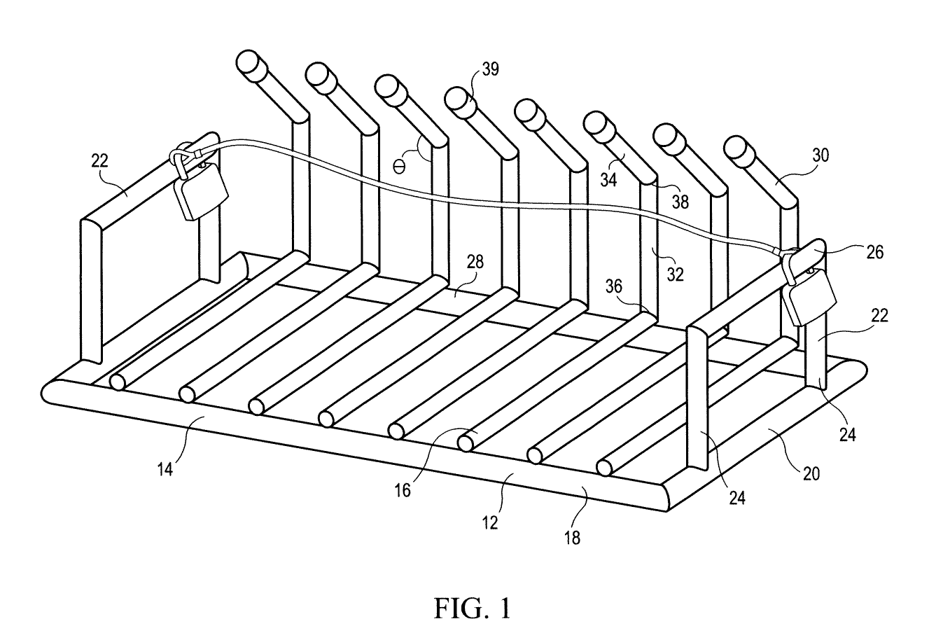

With reference to FIG. 1, the present embodiments comprise a rack 10 configured to allow for the storage and display of one or more firearms, such as handguns. As described further below, the firearms are mounted by their barrels in a downwardly angled direction, with adequate separation between adjacent firearms to avoid firearm-to-firearm contact, and still provide efficient space utilization.

The rack 10 comprises a base 12 configured to provide a strong framework for the rack 10. The base 12 is substantially flat so that the rack 10 is level when placed on level surfaces, such as shelves in a safe, work surfaces, or display tables. The base 12 comprises an outer frame 14 and a plurality of support braces 16 extending in spaced, parallel fashion across the base 12 and secured thereto at either end, for example by welding. In the illustrated embodiment, the outer frame 14 is rectangular, but could be any shape. The support braces 16 extend between long sides 18 of the outer frame 14 and parallel to short sides 20 of the outer frame 14.

In one embodiment, the outer frame 14 may be constructed of a plurality of bars or rods formed in the shape of a rectangle and welded into a single continuous piece. In another embodiment, the outer frame 14 may be constructed of a single bar or rod bent at three places to form the shape of a rectangle with the two ends of the bar or rod secured to one another.

The dimensions of the base 12 depend upon the number and type of firearms the rack 10 is designed to accommodate. The length and the width of the base 12 are preferably proportioned to provide stability. In an eight-handgun configuration, the base 12 may be approximately 8″×16″.

Opposite ends of the frame 14 include upwardly extending handles 22. Each handle 22 is shaped substantially as an inverted U, and is secured to one of the short ends 20 of the frame 14. Each handle 22 is preferably permanently secured to the base 12, for example by welding. Together, each handle 22 and a portion of the short end 20 between vertical posts 24 of the handle 22 form a closed loop. The handles 22 thus provide a strong closed-loop cable passageway in addition to sturdy grasping areas. The handles 22 are preferably sized to provide adequate size for gripping by very large adult-sized hands, and are preferably long enough in a grasping area 26 so that the hands can be positioned in the middle of each handle 22, toward the front of each handle 22, or toward the back of each handle 22, so that the rack 10 can be balanced in an ergonomic position.

A rear portion 28 of the base 12 includes a plurality of spaced barrel supports 30 extending upwardly therefrom. Each barrel support 30 comprises a support post 32 that extends substantially vertically upward from the base 12, and a barrel-receiving portion 34 that extends diagonally upward and away from the upper end of the support post 32 and toward an interior area of the rack 10. Each barrel support 30 is configured to receive a barrel of a firearm with the barrel-receiving portion 34 located within the barrel. In the illustrated embodiment, eight barrel supports 30 are shown. However, the rack 10 may include any number of barrel supports 30 from one to N, where N may be any number.

The rack 10 may include a coating to resist corrosion so that corrosion is not transferred to the interiors of barrels supported on the supports 30. In some embodiments, the coating may be a powder coating. In the illustrated embodiment, each of the barrel-receiving portions 34 may include a cap 39 fitted to its end. The caps 39, which may be elastomeric, for example, cushion the interface between each of the barrel-receiving portions 34 and a firearm mounted thereon to reduce the likelihood of damage to the firearm. In another embodiment. the barrel supports 30 may include a coating over all or substantially all of its surface to further protect the barrel of the firearm. The coating may be an elastomeric material, such as rubber.

In the illustrated embodiment, each barrel support 30 is a unitary extension of a corresponding one of the support braces 16. That is, each support brace 16 and a corresponding one of the barrel supports 30 comprise a single piece that is bent in two places, first at a substantially 90° angle at a junction 36 of the support brace 16 and the support post 32, and again at an obtuse angle θ at a junction 38 of the support post 32 and the barrel-receiving portion 34. In alternative embodiments, each barrel support 30 may be formed separately from the support braces 16. For example, the barrel supports 30 may be secured to the frame 14 in a preferably permanent fashion, such as by welding. In still further alternative embodiments, each barrel support 30 may comprise separate pieces for the support post 32 and the barrel-receiving portion 34. If separate pieces, they may be secured to each other in a preferably permanent fashion, such as by welding.

As discussed above, the angled barrel-receiving portions 34 extend over the base 12. This configuration provides stability to the rack 10, because when firearms are mounted on the barrel supports 30 the mass of each firearm is positioned over the base 12. The receiving portions are preferably angled sufficiently so that the force of gravity keeps each firearm in place, pointed in a partially downward direction. For example, the angle θ may be between about 100° and about 140°, and is preferably about 120°.

The number of barrel supports 30 provided for the rack 10 will be dictated by user preference. The barrel supports 30 may be evenly spaced across the base 12 and parallel to one another, or they may be unevenly spaced so that the rack 10 is configured to accommodate firearms of varying widths. The base 12 of each barrel support 30 may be approximately two inches long.

The rack 10 is preferably constructed of a sturdy material that is difficult to break or sever. For example, the rack 10 may comprise a metal and/or alloy such as steel, aluminum, magnesium, tungsten, etc., and may be case hardened for extra strength. Alternatively, the rack 10 may comprise a composite material, such as a carbon-fiber-reinforced polymer (CFRP), an aramid such as KEVLAR®, fiberglass, or any other composite.

The present storage and display rack 10 for multiple firearms provides many advantages. For example, it enables one or more firearms to be securely mounted therein by inserting each of the barrel support(s) 30 into a corresponding barrel of each firearm. The configuration of the barrel supports 30, which extend over the base 12, place the center of gravity of each firearm over the flat and rectangular base 12, thereby providing stability for as few as one firearm up to the maximum capacity of the rack 10. A diameter and material properties of each barrel support 30 are preferably selected to accommodate firearms of any caliber, such as for example as small as .17 up to as large as .50 caliber, with sufficient strength and stiffness to allow a full-sized large-caliber firearm to be mounted without bending the barrel support 30, although some flexing may occur when supporting large firearms.

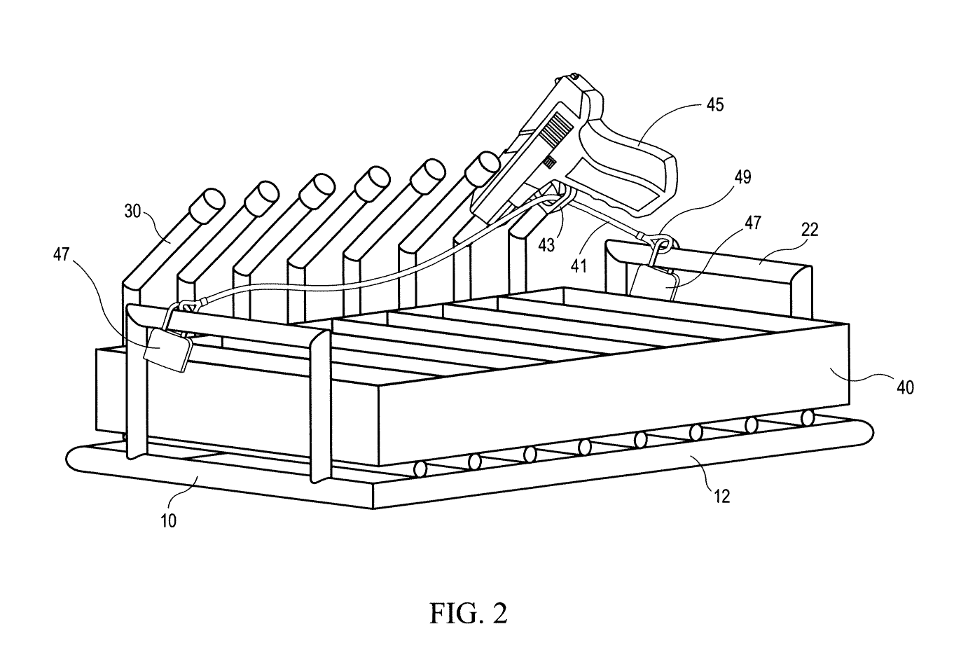

The rack 10 is also advantageously portable. Whether the rack 10 is empty, partially full, or completely full, the handles 22 located at opposite ends of the rack 10 provide an ergonomic, stable, and effective means to grasp and pick up the rack 10. The size of the handles 22, which are large enough to comfortably accommodate large adult hands, enable the hands to be positioned on the handles 22 for optimal balance so that the rack 10 can be carried safely from one location to another. The handles 22 also provide a closed-loop cable passageway so that firearms mounted on barrel supports 30 can be secured to the rack 10 using a cable lock, as shown in FIG. 2. The cable 41 can be looped through the trigger guard 43 of each firearm 45 and either secured to the handles 22 with padlocks 47, or looped through the handles 22 and the two closed-loop ends 49 of the cable 41 locked to one another with a padlock 47. Any firearms 45 mounted to the rack 10 thus cannot be removed from the rack 10. The cable 41 can also be securely attached to a substantially immovable object, thereby deterring theft of the rack 10 and its contents.

Multiple versions of the present storage and display rack 10 may be provided, with various versions accommodating a different number of firearms, while maintaining the advantageous features described herein. Storage and display racks 10 of different capacities allow the present racks 10 to be used in differently sized environments, such as in safes, display cases, display tables, etc. Storage and display racks 10 of different capacities also provide for the needs of firearm owners with differently sized collections.

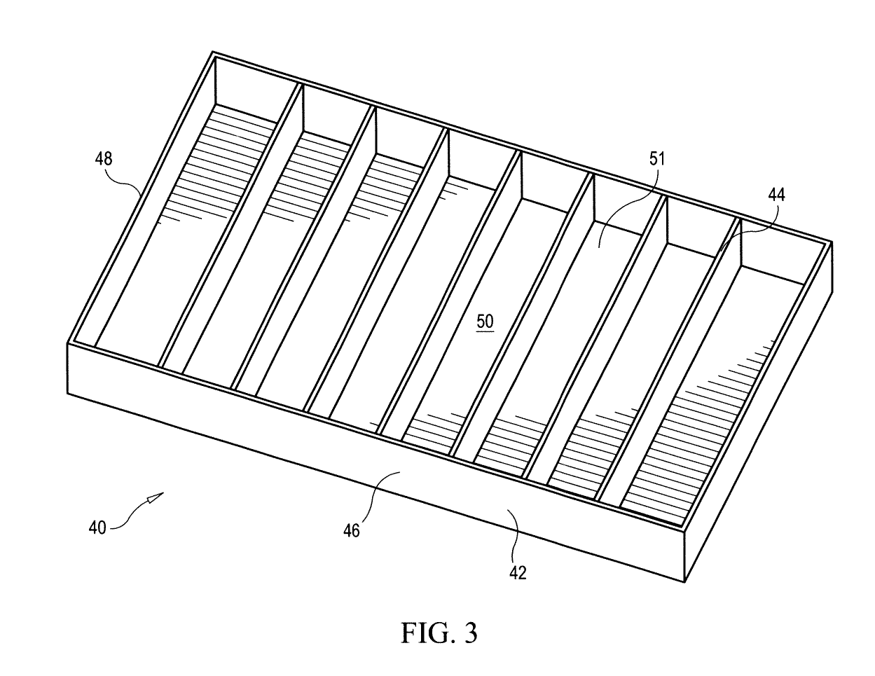

FIG. 3 illustrates an accessories/parts tray 40 configured for use with the rack 10 of FIG. 1. The tray 40 comprises a rectangular outer frame 42 with a plurality of spaced partitions 44 extending between long sides 46 of the outer frame 42 and parallel to short sides of the outer frame 42. Each of the sides 46, 48 of the outer frame 42 and each of the partitions 44 has a height and length that are very large relative to its thickness. The partitions 44 thus divide the tray 40 into compartments 50, as described further below. In alternative embodiments, the partitions 44 may be omitted. The tray 40 further comprises a bottom panel 51 that provides a closed bottom for the tray 40 to support any items placed in the compartments 50.

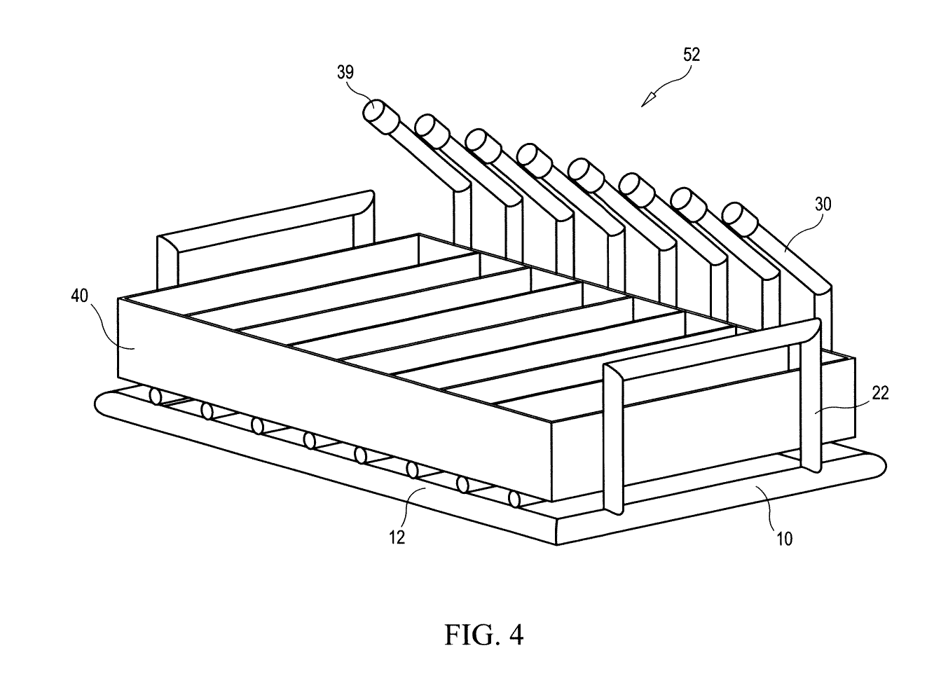

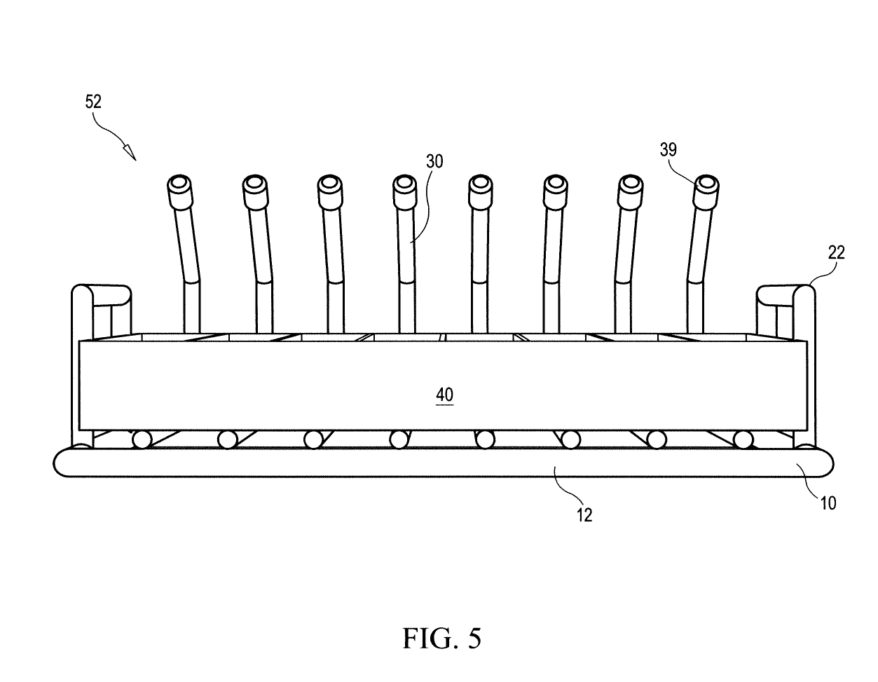

With reference to FIGS. 4 and 5, the tray 40 may be combined with the rack 10 to form a rack-tray combination 52 with the tray 40 mounted on the base 12 between the handles 22 and below the barrel supports 30. Each of the barrel supports 30 is aligned with one of the compartments 50, and may, for example, be centrally aligned therewith. The tray 40 thus provides storage space for firearm accessories and parts, such as spare magazines, cleaning rods, take-down tools, extra grips, etc. The accessories and parts may thus be conveniently stored in close proximity to their associated firearm(s).

The dimensions of the tray 40 are such that it fits on the base 12 between the handles 22 and below the barrel supports 30 while allowing some clearance near the handles 22 and the barrel supports 30 so that the handles 22 can be grasped and firearms can be added to and removed from the barrel supports 30 without the tray 40 interfering. As shown, the handles 22 may have a height greater than the tray 40 to provide additional clearance for grasping the handles 22. While not shown in the figures, the base 12 may be wider than as shown, so that there is a horizontal clearance between the handles 22 and the tray 40. The tray 40 may be constructed of any suitable material, but is preferably durable and supportive. Example materials include, without limitation, wood, metals, and plastics.

Embodiments of the present rack 10, and/or rack 10-tray 40 combination (for simplicity “rack 10”), can be used in a variety of ways by collectors, dealers, and gunsmiths to name a few. For example, the present rack 10 can be used as a storage rack 10 for one or more firearms in a secure location, such as a safe. In a storage application, the rack 10 can be filled with firearms in a work area and safely transported to a secure storage location by grasping the handles 22 and carrying the rack 10 and firearms as one unit. The filled rack 10 can also be safely and securely transported from secure storage to a work area for firearm cleaning and/or inspection, eliminating the need to transport individual firearms. Similarly, a filled rack 10 can be easily and safely transported to and from a showcase, or display table. Embodiments of the present rack 10 further provide for easy in-place removal and replacement of any individual firearm, even when the rack 10 is located in a confined area with little headroom clearance, such as a safe or secure storage cabinet. In secure storage, space is both precious and limited. The ability to easily, and without damage to the firearm, remove and replace the firearm, without requiring rack 10 repositioning or extra headroom, is a significant advantage.

Because of the locking feature described above, embodiments of the present rack 10 can also be used to securely display multiple firearms on a display table, in a retail setting, or in other public venues without concern about potential unauthorized removal of mounted firearms.

The above description presents the best mode contemplated for carrying out the present portable storage and display rack for multiple firearms, and of the manner and process of making and using it, in such full, clear, concise, and exact terms as to enable any person skilled in the art to which it pertains to make and use this portable storage and display rack. This portable storage and display rack is, however, susceptible to modifications and alternate constructions from that discussed above that are fully equivalent. Consequently, this portable storage and display rack is not limited to the particular embodiments disclosed. On the contrary, this portable storage and display rack covers all modifications and alternate constructions coming within the spirit and scope of the portable storage and display rack as generally expressed by the following claims, which particularly point out and distinctly claim the subject matter of the portable storage and display rack.

What is claimed is:

1. A portable storage and display rack for multiple firearms, the rack comprising:
a substantially flat base;
first and second handles extending upwardly from opposite ends of the base; and
a plurality of spaced barrel supports extending upwardly from a rear portion of the base;
wherein each barrel support comprises a support post that extends substantially vertically upward from the base, and a barrel-receiving portion that extends diagonally upward and away from the upper end of the base and toward an interior area of the rack.

2. The rack of claim 1, wherein the base comprises an outer frame and a plurality of support braces extending in spaced, parallel fashion across the base.

3. The rack of claim 2, wherein the outer frame is rectangular, and the support braces extend between long sides of the outer frame and parallel to short sides of the outer frame.

4. The rack of claim 3, wherein each handle is shaped substantially as an inverted U, and is secured to one of the short sides of the frame.

5. The rack of claim 4, wherein each handle is permanently secured to the base.

6. The rack of claim 5, wherein, together, each handle and a portion of the base between vertical posts of the handle form a closed loop configured to receive a cable.

7. The rack of claim 1, wherein each barrel support is configured to receive a barrel of a firearm with the barrel-receiving portion located within the barrel.

8. The rack of claim 2, wherein each barrel support is a unitary extension of a corresponding one of the support braces.

9. The rack of claim 8, wherein each of the support braces and a corresponding one of the barrel supports comprise a single piece that is bent in two places.

10. The rack of claim 8, wherein the single piece is bent at a substantially 90° angle at a junction of the support brace and the base, and at an obtuse angle θ at a junction of the base and the barrel-receiving portion.

11. The rack of claim 1, wherein the rack is constructed of a sturdy material that is difficult to break or sever.

12. The rack of claim 11, wherein the rack is constructed of a metal, alloy and/or a composite material.

13. The rack of claim 1, further comprising an accessory tray.

14. The rack of claim 13, wherein the tray comprises a rectangular outer frame with a plurality of spaced partitions extending between long sides of the outer frame and parallel to short sides of the outer frame.

15. The rack of claim 14, wherein the partitions divide the tray into compartments.

16. The rack of claim 15, wherein the tray is mounted on the base between the handles and below the barrel supports.

17. The rack of claim 16, wherein each of the barrel supports is aligned with one of the compartments.
